(19) United States
(12) Patent Application Publication
(10) Pub. No.: US 2021/0304022 A1
(43) Pub. Date: Sep. 30, 2021

(54) HORIZONTAL LEARNING METHODS AND APPARATUS FOR EXTRACTING ASSOCIATION RULES

(71) Applicant: Crypteia Networks S.A., Athens (GR)

(72) Inventors: Theocharis TSIGKRITIS, Athens (GR); Moti SCHNEIDER, Raanana (IL)

(21) Appl. No.: 16/864,355

(22) Filed: May 1, 2020

(30) Foreign Application Priority Data
Mar. 31, 2020 (GR) 20200100164

(51) Int. Cl. G06N 5/02; G06N 20/00

(52) U.S. Cl. CPC G06N 5/025; G06N 20/00

(57) ABSTRACT

The present disclosure relates to a system and methods for extracting association rules from datasets.

### BACKGROUND OF THE INVENTION

### Field of the Invention

The present disclosure relates to extracting association rules from datasets. In particular, but not exclusively, the present disclosure relates to horizontal learning methods and apparatus for extracting association rules from datasets.

### Description of the Related Technology

Data mining systems can be used for detecting associations between items in a database. Association rule learning is a machine learning approach for finding relations among attributes within one or more datasets. Conventional association rule learning requires considerable computation time and memory requirements in the process of discovering the association rules.

Hence there is a need for a method and system that is capable of overcoming one or more of the above identified challenges.

### SUMMARY

According to embodiments, there is provided a non-volatile computer readable medium storing instructions that, when executed by one or more processors, cause the one or more processors to perform a method for discovering association rules by processing records in a dataset having records and attributes, the method comprising: scanning each of the records for non-zero data; computing subsets for each record, excluding zero-subsets; transforming the computed subsets for each record into itemsets; determining a support for the itemsets; storing the itemsets in a table along with the support corresponding to each of the itemsets; and establishing at least one association rule based at least in part on the support for at least one itemsets.

According to embodiments, there is provided a non-transitory computer readable medium storing instructions, which when executed by one or more processors performs a method for extracting association rules from a dataset having records and attributes, the method comprising: defining a table of itemsets and support; for each record in the dataset: determining the locations of non-zero values; creating a binary subset table having all possible subsets for the record; transforming the binary subset table into an expanded subset table having all possible itemsets for the record; and for each itemset for the record, adding the itemset to the table if the itemset is not already in the table, and incrementing the support associated with the itemset if the itemset is already in the table; wherein, after all the itemsets for all the records of the dataset are included in the table, each row of the table represents an itemset and support for the itemset; and using at least one itemset and support from the table to establish at least one association rule for the dataset.

According to embodiments, there is provided a method for discovering association rules in a dataset having records and attributes, the method comprising: processing records in the dataset, including: scanning each of the records for non-zero data; computing subsets for each record, excluding zero-subsets; transforming the computed subsets for each record into itemsets; determining a support for the itemsets; storing the itemsets in a table along with the support corresponding to each of the itemsets; and establishing at least one association rule based at least in part on the support for at least one itemsets.

Further features of the present disclosure will become apparent from the following description of embodiments, given by way of example only, which is made with reference to the accompanying drawings.

### BRIEF DESCRIPTION OF THE DRAWINGS

FIG. 1 shows a method for discovering associations rules in a dataset, according to embodiments;

FIG. 2 shows a dataset from which association rules can be extracted using methods described herein, according to embodiments;

FIG. 3 shows a table that includes itemset and support for all the records of the dataset shown in FIG. 2, according to embodiments;

FIG. 4 shows a method used in extracting association rules according to embodiments;

FIG. 5 shows subsets of a record of the dataset shown in FIG. 2, according to embodiments;

FIG. 6 shows subsets of the record shown in FIG. 5 transformed to itemsets, according to embodiments;

FIG. 7 shows a table having itemsets and support for the itemsets shown in FIG. 6, according to embodiments;

FIG. 8 shows subsets of another record of the dataset shown in FIG. 2, according to embodiments;

FIG. 9 shows subsets of the record shown in FIG. 8 transformed to itemsets, according to embodiments;

FIG. 10 shows a table having itemset and support for the itemsets shown in FIGS. 6 and 9, according to embodiments;

FIG. 11 shows subsets of yet another record of the dataset shown in FIG. 2, according to embodiments;

FIG. 12 shows subsets of the record shown in FIG. 11 transformed to itemsets, according to embodiments;

FIG. 13 shows a table having itemset and support for the itemsets shown in FIGS. 6, 9, and 12, according to embodiments;

FIG. 14 shows a reduction of the table shown in FIG. 3, according to embodiments; and

FIG. 15 shows a computing device that can be used to implement one or more of the methods described herein, according to embodiments.

### DETAILED DESCRIPTION OF CERTAIN INVENTIVE EMBODIMENTS

Before proceeding with the detailed description, it is to be appreciated that the present teaching is by way of example only, not by limitation. The concepts herein are not limited to use or application with a specific system or method for providing or using horizontal learning methods and a horizontal learning system apparatus for extracting association rules. Thus, although the instrumentalities described herein are for the convenience of explanation shown and described with respect to exemplary embodiments, it will be understood and appreciated that the principles herein may be applied equally in other types of systems and methods for extracting association rules from datasets.

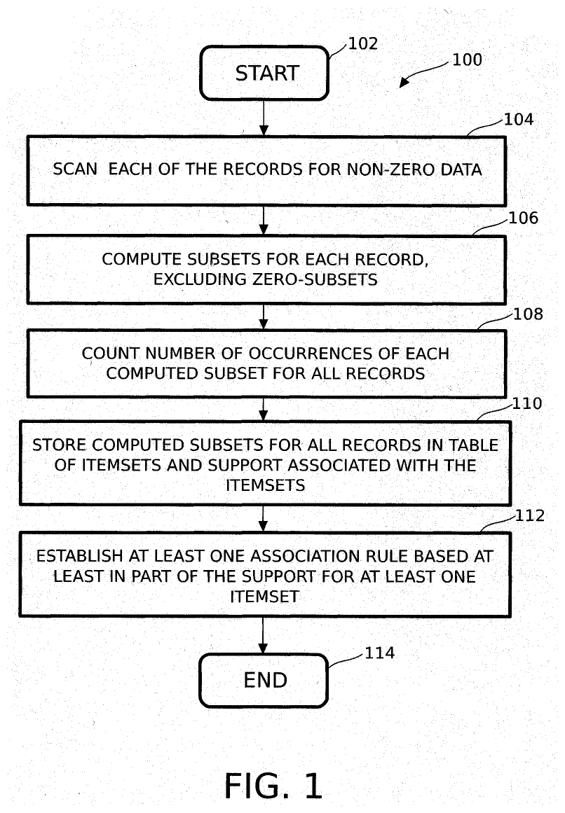

This invention is described with respect to preferred embodiments in the following description with reference to the Figures, in which like numbers represent the same or similar elements. Further, with the respect to the numbering of the same or similar elements, it will be appreciated that the leading values identify the Figure in which the element is first identified and described, e.g., element 100 first appears in FIG. 1.

Novel methods for extracting association rules are disclosed. The methods can include analyzing each record in a dataset, extract possible itemsets from the dataset and computing the support for each itemset. Itemsets can include associated variables that can be used, along with the itemset support, for determining association rules. Embodiments present approaches to discover association rules from one or more datasets while reducing computation time and memory requirements in the process of discovering the association rules.

For the following description of the present invention, FIG. 1, presents a high-level overview, for a method of discovering association rules in a dataset in accordance with at least one embodiment of the present invention. As shown in FIG. 1, a method 100 for discovering association rules by processing records in a dataset having records and attributes can begin at a start 102. The method 100 can then proceed to scan each of the records for non-zero variable data, block 104. Subsets for each record, excluding zero-subsets, are then computed, block 106. Next, the method is continued by counting the number of occurrences or each computed subset for all records of the dataset, block 108. Continuing, the computed subsets for all the records in the dataset can be stored in a Table which can have itemsets (IS) that are all possible subsets from the dataset, and counters associated with the itemsets that store the number of occurrences of each of the itemsets, block 110. The counters can represent support (Sup) for the itemsets. At least one association rule is then established based at least in part on at least one itemset and the support for the at least one itemset in the Table, block 112. Method 100 ends at 114.

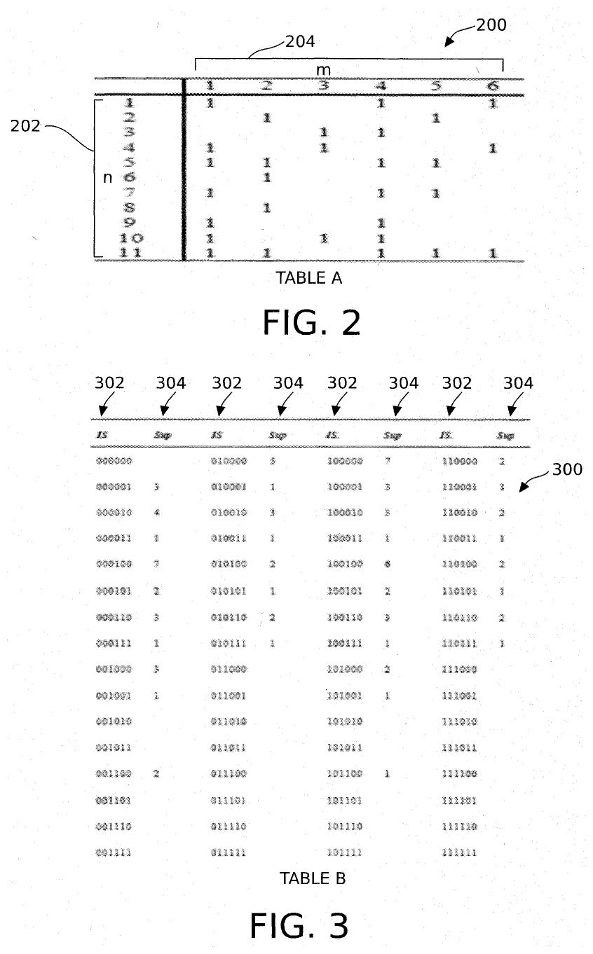

The dataset can be a dataset 200, such as for example Table A, (as shown in FIG. 2), that can contain m variables (also referred to as attributes) and n transactions (also referred to as records). By processing the dataset 200, a new Table B (300) (FIG. 3) can be created that will have at the most

$$B = n \times {2}^{\frac{m}{2}}$$

rows and 2 columns, shown in FIG. 3 in three repeating sets of 2 columns for ease of illustration. The first column of Table B (300) are itemsets 302 or IS which contain sequences of 0's and non-zeros values that represent all possible subsets that can be generated from the records 202 (or n) in Table A. The second column of Table B are the support 304, (or Sup), which are the count of the number of times each subset was generated during the construction of Table B. The transformation of dataset 200 in Table A into Table B (300) can be represented as shown below:

$$A = n \times m \to B = n \times {2}^{m / 2} \times 2$$

Table A in FIG. 2 shows the example binary dataset 200 from which association rules can be extracted using the methods shown in FIG. 1. Dataset 200 includes eleven records 202(n), which can also be referred to as transactions, each of the records 202 in Table A can have one or more of up to six variables 204(m). While the dataset 200 shown in Table A includes eleven records 202 and six variables 204, a dataset can include more or less records, and each record can include more or less variables than what is shown in FIG. 2. In a typical case, the dataset can include many more records than dataset 200. In other datasets, the variables can be binary or non-binary data.

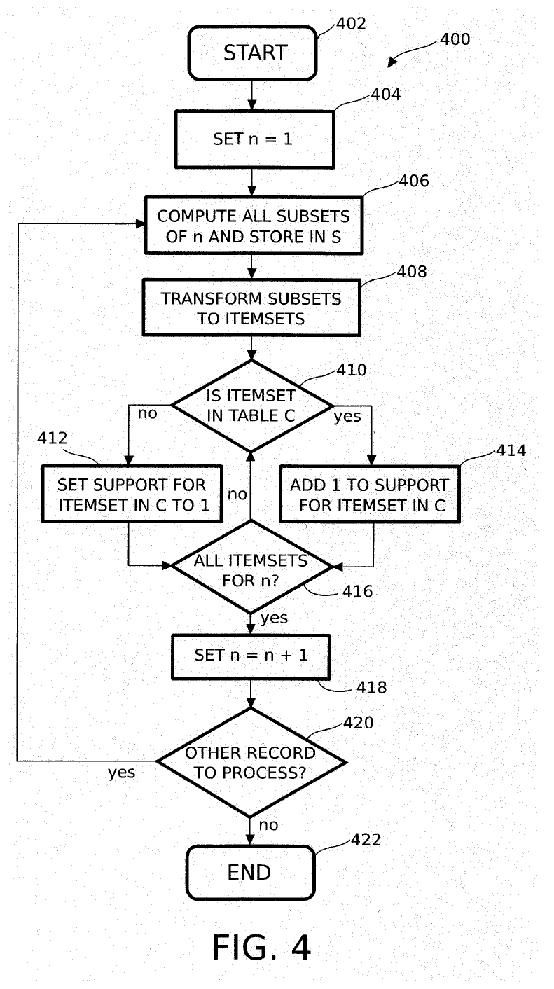

FIG. 4 shows a method 400 for transforming dataset 200 in Table A in FIG. 2 into Table B (300) having possible itemsets 302 (IS) and support 304 (Sup), as shown in FIG. 3, which can be used to discover associations among records encoded in the dataset, according to embodiments.

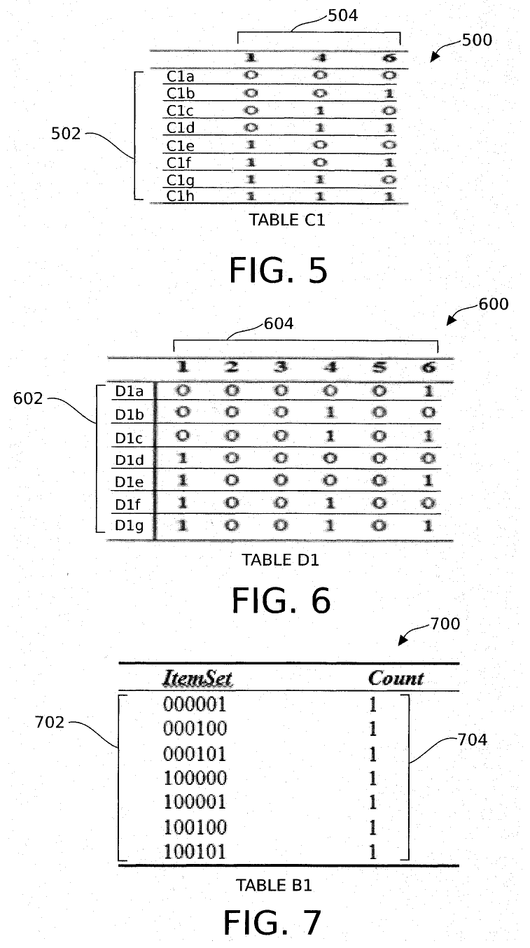

Method 400 begins at a start 402 and can proceed to block 404 where a first record n is selected from dataset 200, e.g., n=1. Method 400 then proceeds to block 406 where all of the interesting subsets of n are computed, and are stored in a Table C1 (500), FIG. 5. FIG. 5 shows Table C1 (500) which includes the subsets 502 of record 202 (n=1). Table C1 can be constructed from the possible combinations of the variable entries 504, e.g. variables m 204 showing a 1 value for 1, 4 and 6 in Table A of FIG. 2. There are 7 subsets of this record since record 202 (n=1) includes three variable entries, i.e., variables 1, 4, and 6 from record n=1 in Table A. Since there are three variables in record 202 (n=1), Table C1 can be represented as a three digit binary table, however since the subset having all zeros is not interesting for use in determining an association rule it is ignored and not included in Table C1. Accordingly, Table C1 includes 7 possible consolidated subsets 502 for the first record 202 (n=1): subset C1a=“001”; C1b=“010”; C1c=“011”; C1d=“100”; C1e=“101”; C1f=“110”; and C1g=“111”.

Method 400 (FIG. 4) then proceeds to block 408 where the results of Table C1 are transformed into expanded subsets, shown in Table D1 in FIG. 6. Table D1 (600) shows a transformation of the consolidated subsets 502 of the record 202 (n=1) shown in FIG. 5 transformed into expanded subsets which can be referred to as itemsets 602.

The transformation Table D1 (600) includes transforms of the 7 interesting consolidated subsets of Table C1 transformed into 7 countable itemsets 602. Each of the itemsets 602 represent one of the subsets of Table C1 that has been expanded, (or transformed), to include the same number of potential variables 604 as the variables (m) 204 seen in the dataset 200 in Table A, (FIG. 2). Itemsets 602 are transformed from Table C1 to include zero values for the variables that are not represented in Table C1, i.e., 2, 3, and 5. Therefore for record n=1, since subset C1a=“001” for the variables (m) 1, 4, and 6, the subset is transformed to a corresponding itemset D1a=“000001” by including zero values in the 2, 3, and 5 variable positions. As another example, since subset C1f=“110” for the variables 1, 4, and 6, the subset is transformed to a corresponding itemset D1f=“100100” by including zero values in the 2, 3, and 5 variable positions. The transformation is similarly made for all the subsets in Table C1.

Method 400 (FIG. 4) then proceeds to decision 410, where a determination is made as to whether the itemsets 602 from Table D1 are already in Table B. Table B (300) in FIG. 3 includes all of the itemsets for dataset 200 after processing all of the records n. In the present example, since the record being processed is n=1 the Table B has yet to be constructed so there are currently no itemsets in Table B and it is represented by Table B1 (700) shown in FIG. 7. Table B1 (700) represents the incomplete Table B (300) after only the first record n=1 has been processed. Itemsets in Table B1 are denoted by reference number 702, and support for itemsets in Table B1 are denoted by reference number 704.

If the determination at decision 410 is that the itemset is not in Table B1, the determination is “no”, and the method 400 proceeds to block 412 where the itemset (702) is added to Table B1 and support (704) for that itemset is set to 1. If the determination at decision 410 is that the itemset is already in Table B1, the determination is “yes”, and the method 400 proceeds to 414 where the support (704) for that itemset (702) is incremented by 1. The determination is made for each itemset in Table D1.

Following block 412 or block 414 as determined from decision 410, the method 400 proceeds to decision 416 to determine if all of the itemsets 702 for record n are added or incremented in Table B1. If the determination at decision 416 is that there are more itemsets, then the method 400 returns to decision 410. For the first run of method 400, none of the itemsets 702 were previously in Table D1 since the record is currently n=1, which is the first record to be processed in this example. If the determination at decision 416 is that there are no more itemsets for this particular record n, then the method 400 proceeds to block 418. At 418, the method 400 increments for the next record—i.e., sets n=n+1.

Method 400 then proceeds to decision 420 where a determination is made as to whether there are more records in dataset 200 in Table A, FIG. 2. If there are more records, then the method 400 returns to block 406 to compute the subsets of the next record n. If there are no more records then the method 400 proceeds to block 422 where method 400 ends. Once all of the records for dataset 200 are processed, the Table B is complete, as is shown in FIG. 3.

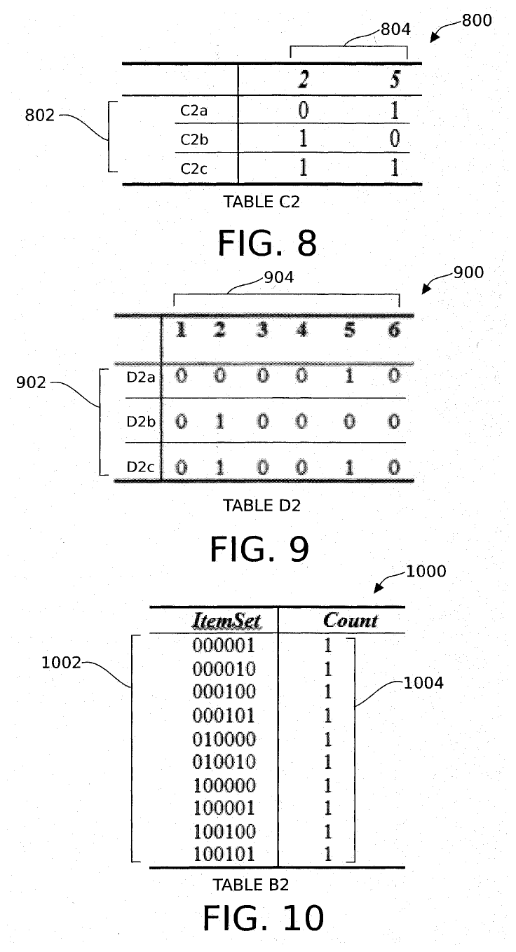

In the present embodiment, following the processing of the record n=1, the determination at decision 420 is that there are additional records to process. Therefore, Table B1 (700) shown in FIG. 7 is incomplete and method 400 returns to block 406 to process another record 202, which in this case is record n=2. Method 400 computes all of the subsets of n=2 at block 406 which are stored in a Table C2 (800), as shown in FIG. 8.

Table C2 (800) includes subsets 802 of record 202 (n=2) from dataset 200 in FIG. 2. Table C2 can be constructed from the possible combinations of the variable entries 804 for n=2, e.g. variables m 204 showing a 1 value for 2 and 5 in Table A of FIG. 2. There are 3 subsets of this record since record 202 (n=2) includes two variable entries 804, i.e., variables 2 and 5. Table C2 can be represented as a two digit binary table, however again, the all zero row is not included in Table C2 (800) since it is not interesting for use in determining association rules. This leaves the 3 subsets 802 of record 202 (n=2) in Table C2 that are of interest: C2a=“01”; C2b=“10”; and C2c=“11”.

Method 400 (FIG. 4) then proceeds to block 408 where the results of Table C2 (800) are transformed into expanded subsets, shown in Table D2 in FIG. 9. Table D2 (900) shows a transformation of the consolidated subsets 802 of the record 202 (n=2) shown in FIG. 8 transformed into expanded subsets which can be referred to as itemsets 902. The transformation Table D2 (900) includes transforms of the 3 interesting consolidated subsets of Table C2 into 3 countable itemsets 902. Each of the itemsets 902 represent one of the subsets of Table C2 that has been expanded, or transformed, to include the same number of potential variables 904 as the variables (m) 204 seen in the dataset 200, FIG. 2. Itemsets 902 are transformed from Table C2 (800) to include zero values for the variables that did not have a variable entry 804 in Table C2 (800), i.e., 1, 3, 4, and 6. Therefore, for record n=2, subset C2a=“01” is expanded to D2a=“000010”; C2b=“10” is expanded to D2b=“010000”; and C2c=“11” is expanded to D2c=“010010” by including zero values in the 1, 3, 4, and 6 variable positions.

Method 400 (FIG. 4) then proceeds to decision 410 where a determination is made as to whether the itemsets from Table D2 (FIG. 9) are already in the Table B being constructed, i.e., Table B1 shown in FIG. 7. In the present embodiment, none of the itemsets 902 from Table D2 (900) for record n=2 were already in Table B1 (700). Therefore, itemsets 902 are added to Table B1 (700) and the support for each of these itemsets is set to 1 by following through method 400 steps 410-416. Table B2 results from adding itemsets 902 to Table B1. Table B2 (1000) shows itemsets 902 (see Table D2 in FIG. 9) and support 1004 resulting from the processing of records n=1 and n=2. FIG. 10 shows Table B2 (1000) having itemsets 1002 and support 1004 for the itemsets 902 shown in Table D2 in FIG. 9, and itemsets 602 from Table D1 (600) in FIG. 6.

Once all of the itemsets for n=2 are processed, and the determination at decision 416 is that there are not more itemsets for this particular record n, then the method 400 proceeds to block 418. At block 418, the method 400 sets n=n+1, i.e., n=3. Method 400 then proceeds to decision 420 where a determination is made as to whether there is another record, (n=3), in dataset 200.

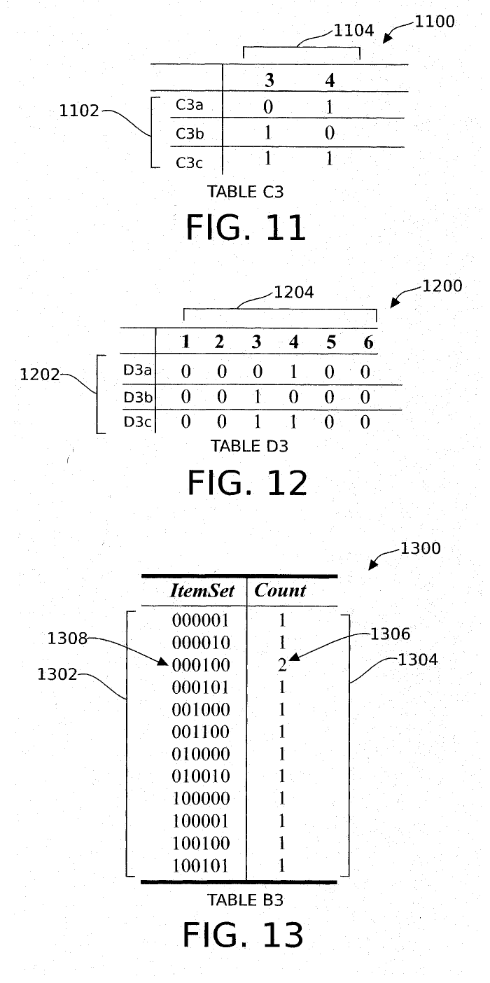

In the present embodiment, following the processing of the record n=2, the determination at 420 is that there are additional records to process. Therefore, Table B2 (1000) shown in FIG. 10 is incomplete and method 400 returns to block 406 to process another record 202, which in this case is record n=3. Method 400 computes all of the subsets of n=3. at block 406 which are stored in a Table C3 (1100), as shown in FIG. 11. Table C3 (1100) includes subsets 1102 of record 202 (n=3) from dataset 200 in FIG. 3. Table C3 (1100) can be constructed from the possible combinations of the variable entries 1104 for n=3, e.g. variables m 204 showing a 1 value for 3 and 4 in Table A of FIG. 2. There are 3 subsets of this record since record 202 (n=3) includes two variable entries 1104, i.e., variables 3 and 4 from Table A in FIG. 2. Since there are two variables in record 202 (n=3), Table C3 can be represented as a two digit binary table, excluding the all zero case. This leaves the 3 the subsets 1102 for record 202 (n=3) in Table C3 (1100) that are of interest. Accordingly, Table C3 includes 3 possible consolidated subsets 1102 for the third record 202 (n=3): subset C3a=“001”, C3b=“10”; and C3c=“11”.

Method 400 then proceeds to block 408 where the results of Table C3 (1100) are transformed into expanded subsets, shown in Table D3 in FIG. 12. Table D3 (1200) shows a transformation of the consolidated subsets of the record 202 (n=3) shown in FIG. 11 transformed into expanded subsets which can be referred to as itemsets 1202. The transformation Table D3 (1200) includes transforms of the 3 interesting consolidated subsets of Table C3 (1100) transformed into 3 countable itemsets 1202. Each of the itemsets 1202 represent one of the subsets of Table C3 (1100) that has been expanded, or transformed, to include the same number of potential variables 1204 as the variables (m) 204 seen in the dataset 200, FIG. 2. Itemsets 1202 shown in Table D3 in FIG. 12 are transformed from Table C3 (1100) to include zero values for the variables not shown in Table C3, i.e., variables 1, 2, 5, and 6.

Therefore, for record n=3, subset C3a=“01” is expanded to D3a=“000100”; C3b=“10” is expanded to D3b=“001000”; and C3c=“11” is expanded to D3c=“001100” by including zero values in the 1, 2, 5, and 6 variable positions.

FIG. 13 shows Table B3 (1300) having itemsets 1302 and support 1304 for the itemsets shown in FIG. 12. Table B3 (1300) includes itemsets 1002 from Table B2 (1000) in FIG. 10 and itemsets 1202 from Table D3 in FIG. 12. In the present embodiment, itemset D3a=“000100” from Table D3 (1200) was already in Table B2 (1000) and so method 400 proceeds from decision 410 to block 414 where the support, or count 1306 is incremented to “2” for that itemset 1308. The other itemsets “001000” and “001100” for record n=3 were not already in Table B2 (1000), therefore these itemsets are added to Table B3 (1300) and the support 1304 for each of these itemsets is set to 1 in method 400. Since there are no more itemsets for this particular record n, then the method 400 proceeds to block 418. At block 418, the method 400 sets n=n+1. Method 400 then proceeds to decision 420 where a determination is made as to whether there are more records in dataset 200. The method 400 continues in the manner discussed until all of the records 202 in dataset 200 are processed.

Once all the records are processed for dataset 200 (Table A) in FIG. 2, method 400 proceeds to end at block 422 and Table B (300) is complete, as shown in FIG. 3. Table B (300) provides the necessary information needed to construct possible association rules. In Table B there are 37 itemsets 302 out of 64 possible itemsets that have a support 304 that is 1 or more, and 22 itemsets that have support that is 2 or more. By designing Table B as a hash Table, then only half of the memory is needed to store relevant itemsets.

Association rules can be determined from the completed Table B (300). In an example, to extract association rules associated with “100110” there are six choices and the confidence for each can be calculated as follows:

$$conf ( {}_{}^{″}{100100}{}_{}^{″} ⇒ {}_{}^{″}{100010}{}_{}^{″} ) = \frac{Supp ( {}_{}^{″}{100110}{}_{}^{″} )}{Supp ( {}_{}^{″}{000100}{}_{}^{″} )} = 3 / 7$$

$$conf ( {}_{}^{″}{000010}{}_{}^{″} ⇒ {}_{}^{″}{100100}{}_{}^{″} ) = \frac{Supp ( {}_{}^{″}{100110}{}_{}^{″} )}{Supp ( {}_{}^{″}{000010}{}_{}^{″} )} = 3 / 4$$

$$conf ( {}_{}^{″}{100100}{}_{}^{″} ⇒ {}_{}^{″}{000010}{}_{}^{″} ) = \frac{Supp ( {}_{}^{″}{100110}{}_{}^{″} )}{Supp ( {}_{}^{″}{100100}{}_{}^{″} )} = 3 / 6$$

$$conf ( {}_{}^{″}{100010}{}_{}^{″} ⇒ {}_{}^{″}{000100}{}_{}^{″} ) = \frac{Supp ( {}_{}^{″}{100110}{}_{}^{″} )}{Supp ( {}_{}^{″}{100010}{}_{}^{″} )} = 3 / 3$$

$$conf ( {}_{}^{″}{000110}{}_{}^{″} ⇒ {}_{}^{″}{100000}{}_{}^{″} ) = \frac{Supp ( {}_{}^{″}{100110}{}_{}^{″} )}{Supp ( {}_{}^{″}{000110}{}_{}^{″} )} = 3 / 6$$

$$conf ( {}_{}^{″}{100000}{}_{}^{″} ⇒ {}_{}^{″}{000110}{}_{}^{″} ) = \frac{Supp ( {}_{}^{″}{100110}{}_{}^{″} )}{Supp ( {}_{}^{″}{100000}{}_{}^{″} )} = 3 / 7$$

If the minimum confidence is set to 0.8, then only one rule is chosen:

$$conf ( {}_{}^{″}{100010}{}_{}^{″} ⇒ {}_{}^{″}{000100}{}_{}^{″} ) = \frac{Supp ( {}_{}^{″}{100110}{}_{}^{″} )}{Supp ( {}_{}^{″}{100010}{}_{}^{″} )} = 1$$

This rule can be translated to: “If m1 and m5 then m4”. This means that every time variables m1 and m5 are set to 1 so is variable m4. This can be confirmed by observing dataset 200 in Table A, shown in FIG. 2. In many applications, such as in anomaly detection, infrequent rules can be of interest, such as rules that can be derived from the string “100001”. In this case, 2 rules can be generated:

$$conf ( {}_{}^{″}{100000}{}_{}^{″} ⇒ {}_{}^{″}{000001}{}_{}^{″} ) = \frac{Supp ( {}_{}^{″}{100001}{}_{}^{″} )}{Supp ( {}_{}^{″}{100000}{}_{}^{″} )} = \frac{3}{7}$$

$$conf ( {}_{}^{″}{000001}{}_{}^{″} ⇒ {}_{}^{″}{100000}{}_{}^{″} ) = \frac{Supp ( {}_{}^{″}{100001}{}_{}^{″} )}{Supp ( {}_{}^{″}{000001}{}_{}^{″} )} = \frac{3}{3}$$

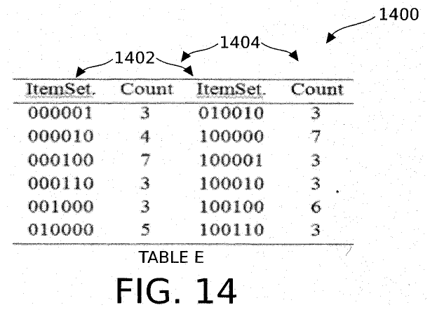

From the above we can see that each time m6 is set to 1 so is m1. In addition, a minimum support (i.e., MinSup=3), can be defined which will result in the reduction of Table B (300), as shown in a Table E (1400) shown in FIG. 14. Table E (1400) can include itemsets 1402 and support (Count) 1404. Using Table E (1400) the largest and/or smallest itemset having some minimum support can be searched. For example, using Table E (1400), the largest itemset is in the string “100110”. In this case 6 possible rules can be generated. Also, there are four itemsets with two 1's in them. Therefore, another 8 different possible rules can be generated. In total, 14 possible rules can be generated from the original dataset 200 without considering the confidence factor.

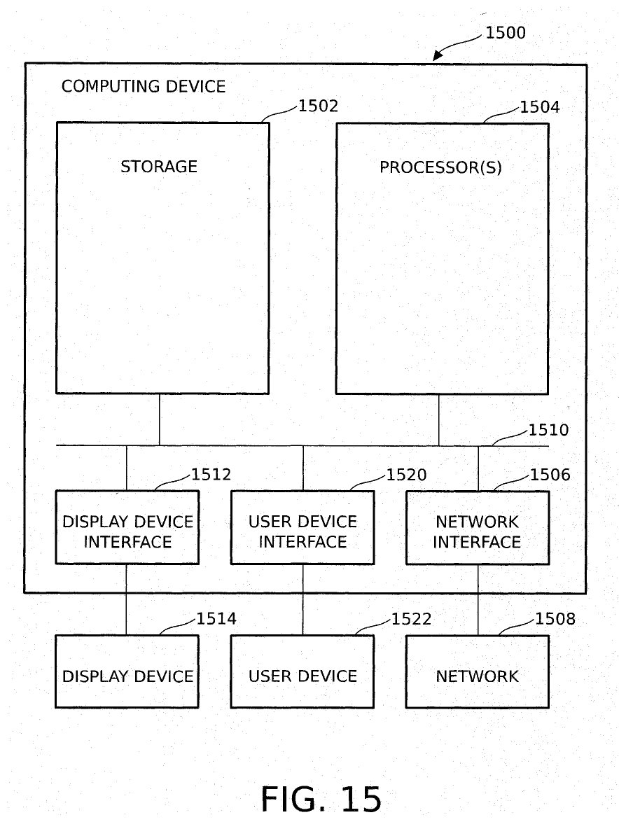

In one or more embodiments, the methods for discovering and extracting association rules using the HL system can be implemented on a computing device. Examples of internal components of a computing device 1500 for use with the methods 100 and 400 described herein is provided with reference to FIG. 15. The computing device 1500 may include storage 1502 which may include one or more volatile memory, such as a Random Access Memory (RAM) and non-volatile memory, such as Read Only Memory (ROM) or a solid state drive (SSD) such as Flash memory. The storage 1502 may include other storage devices, such as for example, magnetic or optical, and may be in a format such as compact disc (CD), digital versatile disc (DVD) or other storage media. The storage 1502 may be removable, such as SD or USB type drives or non-removable from the computing device 1500.

The computing device 1500 may include at least one processor 1504 that is communicatively coupled to the storage 1502. The at least one processor 1504 in the example of FIG. 15 may include a microprocessor, a general-purpose processor, an application specific integrated circuit (ASIC), a digital signal processor (DSP), a field programmable gate array (FPGA) or other programmable logic device, discrete hardware components, a discrete gate or transistor logic, or any suitable combination thereof capable of performing the functions described herein. A processor may also be implemented as a combination of computing devices, such as for example, a plurality of processors, a combination of a DSP and a microprocessor, one or more microprocessors in conjunction with a DSP core, or other such configuration.

The computing device 1500 of FIG. 15 includes a network interface 1506 which can be communicatively connected to a network 1508 to receive data, such as data related to network traffic flow and/or other data. The HL system can accumulate the data from the network 1508 into a dataset in the storage 1502, such as the dataset T (200) shown in FIG. 2.

The storage 1502 in the example of FIG. 15 includes computer program instructions configured to, when processed by the at least one processor 1504, implement a method for discovering or extracting association rules from one or more datasets. The computer program instructions and data may be stored in an accessible non-transitory computer-readable medium and loaded into memory, for example the storage 1502, to implement the methods 100 and/or 400. For example, the storage 1502 can load and store the data in Tables S, F and C, as well as dataset T.

The computing device 1500 may also include an interface 1520 for a user interface 1522. The interface and user interface 1522 may provide a user to interact with the computing device 1500 to input commands, data, and/or other information.

The components of the computing device 1500 in the example of FIG. 15 are interconnected using a systems bus 1510. This allows data to be transferred between the various components. Data generated by the methods, e.g., for example, the dataset 200 shown in Table A in FIG. 2, Tables B (300), B1 (700), B2 (1000), B3 (1300), etc., Tables C1 (500), C2 (800), C3 (1100), etc., and Tables D1 (600), D2 (900), D3 (1200), etc., can be stored in the storage 1502 and subsequently transmitted via the systems bus 1510 for processing by the at least one processor 1504 and from the storage 1502 to a display device interface 1512 for transfer to a display device 1514 for display. The display device interface 1512 may include a display port and/or an internal electronics interface, e.g. where the display device is part of the computing device 1500 such as a display screen of a smart phone. Therefore, when instructed by the at least one processor 1504 via the display device interface 1512, the display device 1514 will display an image based on the discovered association rules.

With respect to the above description, a further example of an embodiment for this system and method may be realized as an advantageous system for diagnosis. With respect to FIG. 2 the dataset 200 for at least one embodiment may be understood and appreciated to be comprised of symptoms as m variables and illnesses as n transactions. More specifically, multiple illnesses may share common symptoms, and in some cases there may be significant overlap, e.g., the flu and mononucleosis. For other more extreme illnesses, an errant diagnosis as a more common condition could be significantly detrimental to the patient. Where an embodiment of the present invention made available to the heath care provider, the rapid and advantageous nature of the methods and systems as described would permit improved granularity to potentially identify and present possible conditions that otherwise might be missed. As new illnesses arise and our systems of commerce, trade and travel become ever more complex and intertwined, the advantages of the present invention to aid in quick diagnosis, and potentially even tracking of spread and origin, are easily understood as highly advantageous adaptations for one or more embodiments.

Further examples of embodiments for this system and methods for association rule extraction or mining can be used to discover associations among records encoded in a dataset in a database. These techniques can be used to improve decision making in a wide variety of applications, such as for example: Geographic Information Systems (GIS), market basket analysis, customer relationship management, census data, marketing, investment, fraud detection, military, pattern recognition, relational database, large database and distributed databases. Embodiments of the system and methods can be used for customer market basket analysis to determine how different parameters influence each other, e.g., relationships between products (n) that are purchased simultaneously in different transactions (m).

Embodiments of the system and methods can be used in customer relationship management, through which, banks can identify preferences of different customer groups, products, and services tailored to the customer liking to enhance cohesion between credit card customers and the bank. In one or more embodiments, different bank customers (m) in a customer group may prefer certain products and/or services (n), while customers in another customer group may have other preferences.

Embodiments of the system and methods can also be used in analyzing census data. Governments collect large amounts of data each census. This data can be used to plan efficient public services, such as education, health, and transport, as well as to help businesses, such as by assisting in set up new factories, shopping malls, and marketing. The application of association rule extraction to census data has the potential to support sound public policy and to bring forth efficient functioning of a democratic society. Variables (n) can include the answers to census questions such as race, gender, income, and residence location, and transactions (m) can be individuals answering the census, for example.

Embodiments of the system and methods can also be used in analyzing data for fraud detection in banks, insurance companies, business, military and healthcare, as examples. In the military, the systems and methods can be used for war gaming, and decision making. The systems and methods can also be used in pattern recognition for image analysis, image understanding, voice reconstruction, voice understanding, text analysis, and/or text understanding, as examples.

The present disclosure introduces a novel approach that discovers association rules by processing records (rows) in a given dataset and not attributes (columns) as found in conventional systems. The discovery process starts by scanning each record for a non-zero data. All possible subsets from that record are computed (excluding the 0-subset) and placed on a table that contains all possible subsets and a counter that counts the number of occurrences of that subset through the entire dataset. The process is repeated for all records in the datasets and the counters are updated accordingly. By the end of the process, the table will contain all possible subsets from the datasets (itemsets) and their counters (support). A run time of a conventional approach can be 2^{m} (where m is the number of attributes in the dataset), the HL approach described herein can yield

$$O ( {2}^{\frac{m}{2}} )$$

in the worst case, where the “O” notation defines the maximum number of operations the algorithm performs in terms of the data size, which in this case is m.

In order to compute the complexity of the algorithm we define the number of variables (items) as m and the number of records n. To be as conservative, the average number of non-zero values in each record can be assumed to be

$$n \times {2}^{\frac{m}{2}} .$$

Under this assumption, the complexity of the process is:

$$\begin{matrix}F = O ( N \times {2}^{\frac{M}{2}} ) \\ and & ( 1 ) \\ M = O ( {2}^{M} ) & ( 2 )\end{matrix}$$

Where F is the processing complexity and M is the memory requirement. For example: for N=1000 and M=20 then C=O (10⁶)≈1Mcycles and M=O (1 Mbyte).

Making an assumption that on the average half of the values in each row have a non-zero value and the number of variables in the dataset is m, this can yield 2^{(m/2)} comparisons. Since there are n rows in the original Table A, the execution time can be n2^{(m/2}). So if F1 is denoted as the itemset count then:

F1=n×2^{m/2} (3)

Conventional systems for determining association rules process attributes (columns), for example in (Savasere, Omiecinski and Navathe, 1995), (Pujari, 9001) and (Das, Bhattacharyya and Kalit, 9008). Comparing columns requires computing 1-itemset, 2-itemset, . . . , m-itemset. In addition, the dataset has to be scanned once (each scan require n comparisons) in order to compute the support. If C2 be the traditional approach to computing the itemsets. Then the total number of operations required for computing the itemsets can be given by Equation 4:

$$\begin{matrix}{C}_{2} = n ( \begin{matrix}m \\ 1\end{matrix} ) + n ( \begin{matrix}m \\ 2\end{matrix} ) + … + ( \begin{matrix}m \\ m\end{matrix} ) \\ = n ( \frac{m !}{1 \times ( m - 1 ) !} + \frac{m !}{2 ! \times ( m - 2 ) !} + … + \frac{m !}{m ! \times ( 1 ) !} ) \\ = n ( {2}^{m} - 1 )\end{matrix} \qquad ( 4 )$$

When Comparing Equations (3) and (4), the coefficient n can be removed. Graph 4 (below) compares the results of using the HL system to a conventional approach, for the two equations for m=[1 . . . 20], where m is the number of variables.

Graph 4 shows that the HL system described herein can reduce the total number of operations required for computing itemsets, which can in turn, reduce the time required to discover association rules for a given dataset.

The above embodiments are to be understood as illustrative examples of the present disclosure. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of embodiments, which is defined in the accompanying claims.

What is claimed is:

1. A non-volatile computer readable medium storing instructions that, when executed by one or more processors, cause the one or more processors to perform a method for discovering association rules by processing records in a dataset having records and attributes, the method comprising:
scanning each of the records for non-zero data;
computing subsets for each record, excluding zero-subsets;
transforming the computed subsets for each record into itemsets;
determining a support for the itemsets;
storing the itemsets in a table along with the support corresponding to each of the itemsets; and
establishing at least one association rule based at least in part on the support for at least one itemsets.

2. A non-volatile computer readable medium as defined in claim 1, wherein the at least one association rule is based on a ratio of the support for the at least one itemset, and support for at least one another itemset.

3. A non-volatile computer readable medium as defined in claim 1, further comprising determining a confidence value of the at least one association rule; and wherein establishing the at least one association rule further comprises:
establishing a threshold confidence value and comparing the confidence value of the at least one association rule to the threshold confidence value.

4. A non-volatile computer readable medium as defined in claim 3, wherein the threshold confidence value is a minimum confidence value and establishing the at least one association rule comprises determining that the confidence value of the at least one association rule exceeds the threshold confidence value.

5. A non-volatile computer readable medium as defined in claim 1, wherein computing subsets for each record comprises creating a binary table of the subsets.

6. A non-volatile computer readable medium as defined in claim 5, wherein the binary table excludes an all zero row of the binary table.

7. A non-volatile computer readable medium as defined in claim 1, wherein establishing the at least one association rule comprises determining a likelihood of an association between at least one attribute in the dataset and at least one other attribute in the dataset.

8. A non-transitory computer readable medium storing instructions, which when executed by one or more processors performs a method for extracting association rules from a dataset having records and attributes, the method comprising:
defining a table of itemsets and support;
for each record in the dataset:
determining the locations of non-zero values;
creating a binary subset table having all possible subsets for the record;
transforming the binary subset table into an expanded subset table having all possible itemsets for the record; and
for each itemset for the record, adding the itemset to the table if the itemset is not already in the table, and incrementing the support associated with the itemset if the itemset is already in the table;
wherein, after all the itemsets for all the records of the dataset are included in the table, each row of the table represents an itemset and support for the itemset; and
using at least one itemset and support from the table to establish at least one association rule for the dataset.

9. A method for discovering association rules in a dataset having records and attributes, the method comprising:
processing records in the dataset, including:
scanning each of the records for non-zero data;
computing subsets for each record, excluding zero-subsets;
transforming the computed subsets for each record into itemsets;
determining a support for the itemsets;
storing the itemsets in a table along with the support corresponding to each of the itemsets; and
establishing at least one association rule based at least in part on the support for at least one itemsets.
